(19) United States
(12) Patent Application Publication
(10) Pub. No.: US 2024/0360343 A1
(43) Pub. Date: Oct. 31, 2024

(54) REACTIVE PRESSURE-SENSITIVE ADHESIVE ELEMENT

(71) Applicant: tesa SE, Norderstedt (DE)

(72) Inventors: Stefan Kramp, Bönningstedt (DE); Michael Egger, Hamburg (DE)

(73) Assignee: tesa SE, Norderstedt (DE)

(21) Appl. No.: 18/643,234

(22) Filed: Apr. 23, 2024

(30) Foreign Application Priority Data
Apr. 25, 2023 (DE) 102023110590.6

(51) Int. Cl. C09J 7/38; C09J 7/26; C09J 11/08; C09J 133/10

(52) U.S. Cl. CPC C09J 7/385; C09J 7/26; C09J 11/08; C09J 133/10; C09J 2301/1242; C09J 2301/302; C09J 2301/312; C09J 2301/416; C09J 2301/50; C09J 2423/00; C09J 2433/00

(57) ABSTRACT

A reactive pressure-sensitive adhesive element that includes: i) a carrier layer; ii) a first adhesive layer arranged on a first surface of the carrier layer that comprises a first UV-curable pressure-sensitive adhesive; and iii) a second adhesive layer arranged on a second surface of the carrier layer facing away from the first surface, wherein the second adhesive layer comprises a second UV-curable pressure-sensitive adhesive. Each of the first and second UV-curable pressure-sensitive adhesives, based on a mass of the respective pressure-sensitive adhesive, comprises: x) one or more poly (meth) acrylate compounds in a combined mass fraction from 35% to 85%; y) one or more polymerizable epoxy compounds in a combined mass fraction from 10% to 50%; and z) one or more photoinitiators in a combined mass fraction from 0.1% to 5%. Further, the carrier layer comprises a foam carrier, the foam carrier comprising one or more polyolefins.

### CROSS-REFERENCE TO RELATED APPLICATIONS

This application claims the benefit of priority under 35 U.S.C. § 119 (b) of German Patent Application No. 102023110590.6, entitled “REACTIVE PRESSURE-SENSITIVE ADHESIVE ELEMENT”, and filed Apr. 25, 2023, the contents of which is relied upon and incorporated herein by reference in its entirety.

### FIELD OF THE DISCLOSURE

The invention relates to a reactive pressure-sensitive adhesive element and to a method for connecting two or more components, in particular for attaching a display to a housing, and also to a substrate bonded therewith and to a method for separating such a bonded substrate. The use of a corresponding reactive pressure-sensitive adhesive element for bonding two or more components is also disclosed.

### BACKGROUND

The joining of separate elements is one of the central processes in manufacturing. In addition to other methods, such as welding and soldering, for example, adhesive bonding, i.e., joining using an adhesive, is of particular importance nowadays. An alternative to the use of formless adhesives, which are applied from a tube, for example, are so-called adhesive tapes. From everyday life, pressure-sensitive adhesive tapes are known, in which a pressure-sensitive adhesive ensures the adhesive effect, which is permanently sticky and adhesive under normal ambient conditions. Pressure-sensitive adhesive tapes can be applied to a substrate by means of pressure and remain adhered, but can later be removed in a more or less residue-free manner.

However, another type of adhesive tape is also of great importance, especially for use in industrial manufacturing. These adhesive tapes, which are also referred to by the skilled person as reactive adhesive tapes, use a curable adhesive. Appropriate curable adhesives have not yet reached their maximum degree of crosslinking in the state intended for application and can be cured by external influences by initiating the polymerization in the curable adhesive and thereby increasing the degree of crosslinking. The mechanical properties of the now cured adhesive change, increasing in surface hardness and strength.

Curable adhesives are known in the art and can have very different compositions from a chemical point of view. These curable adhesives have in common that the crosslinking reaction can be triggered by external influencing factors, by supply of energy, for example, by temperature, plasma or radiation curing, and/or by contact with a polymerization-promoting substance, as is the case, for example, with moisture-curing adhesives. Illustrative reactive adhesives are disclosed for example in DE 102015222028 A1, EP 3091059 A1, EP 3126402 B1, EP 2768919 B1, DE 102018203894 A1, WO 2017174303 Al and U.S. Pat. No. 4,661,542 A. Examples of reactive pressure-sensitive adhesive elements are also disclosed in US 2022/0251432 A1, for example.

Many of the reactive adhesives known from the prior art are inherently not pressure-sensitively adhesive. Accordingly, the reactive adhesive elements produced from them are not self-adhesive on a regular basis. Owing to the lack of pressure-sensitive adhesiveness, it is difficult for some applications to place the corresponding curable reactive adhesive elements in the desired position on a substrate to be bonded before and during the curing process and to remove them again, if necessary, without residue-for example, to correct the seating of an incorrectly positioned adhesive element. Accordingly, pressure-sensitive adhesive characteristics are in principle preferred, especially for the use of corresponding reactive adhesive elements in the electronics industry.

In addition to the primarily applications-related requirements of pressure-sensitive adhesiveness, additional basic requirements are also imposed on double-sided reactive pressure-sensitive adhesive elements, which in many cases, however, hinder the implementation of the applications-related requirements. In addition to an advantageous pressure-sensitive adhesiveness, the double-sided reactive pressure-sensitive adhesive elements should in particular also be quick and reliable to cure and result in a robust structural bonding after curing. In particular in the electronics industry sector, it is important that the reactive pressure-sensitive adhesives used show a high chemical compatibility to the substrates to be bonded, which are made of plastic or metal, for example, and do not react to the substrate surfaces in a harmful manner. In addition, an aim is that the bonded assembly produced by bonding with such double-sided reactive pressure-sensitive adhesive elements should have advantageous mechanical properties that positively influence the robustness and durability of the bond generated.

A particular problem that arises with double-sided reactive pressure-sensitive adhesive elements in the state of the art is that the inherently advantageous durability of the structural bond generated, from the moment at which the substrate thus bonded has reached the end of its lifetime, becomes an obstacle which can prevent the effective recycling of the components of the bonded substrate. For recycling to be advantageous from an ecological and economic point of view, indeed, the individual components must be regularly separated from each other-a display from a plastic housing, for example-which in many cases is not possible or at least not possible with reasonable effort with cured reactive pressure-sensitive adhesive elements which met the exacting requirements for the bond strength during the life of the bonded substrates.

Therefore, there is a need to eliminate or at least reduce the disadvantages of the prior art. In particular, there is a need to specify a double-sided pressure-sensitive adhesive element which is pressure-sensitively adhesive, so that it can be removed from a substrate again substantially without residue before curing, so that reliable processing of the reactive pressure-sensitive adhesive element to be specified is ensured.

There is also a need that the reactive pressure-sensitive adhesive elements to be specified have advantageous technical adhesive properties, especially at elevated temperatures too. In this case, the reactive pressure-sensitive adhesive elements to be specified should in particular have an advantageous peel adhesion before curing, and in addition be curable in a fast and reliable manner, it being desirable that the bonded assembly resulting after curing should have an advantageous bond strength.

Another object is that the reactive pressure-sensitive adhesive elements to be specified should have a high chemical compatibility and compatibility with the substrates typically used in the field of the electronics industry sector, it being particularly desirable that substrates made of plastic or metal are not reacted to in a disadvantageous manner.

Further, the reactive pressure-sensitive adhesive elements to be specified should have an advantageous mechanical property profile after curing, which has a beneficial effect on the durability of the bond generated, especially in the bonding of components in the electronics industry sector-for example, in the fastening of displays in the corresponding receptacles of housings.

In addition, the reactive pressure-sensitive adhesive elements to be specified should open a way to a simple and efficient separation of the bonding despite an advantageous and long-lasting bonding, to enable the recyclability of glued substrates or their glued components in this way, this advantageous separability of the compound should preferably be feasible without the use of potentially harmful chemicals.

Further, there is a need to specify a method for connecting two or more components and a corresponding bonded substrate. In addition, there is a need to specify a method for separating such a bonded substrate. In addition, there is a need to provide a use for the reactive pressure-sensitive adhesive elements to be specified, in the bonding of various components.

### SUMMARY OF THE DISCLOSURE

According to a first aspect of the disclosure, a reactive pressure-sensitive adhesive element is provided that includes: i) a carrier layer; ii) a first adhesive layer arranged on a first surface of the carrier layer, wherein the first adhesive layer comprises a first ultraviolet light (UV)-curable pressure-sensitive adhesive; and iii) a second adhesive layer arranged on a second surface of the carrier layer facing away from the first surface of the carrier layer and the first adhesive layer, wherein the second adhesive layer comprises a second UV-curable pressure-sensitive adhesive. Each of the first UV-curable pressure-sensitive adhesive and the second UV-curable pressure-sensitive adhesive, based on a mass of the respective pressure-sensitive adhesive, comprises: x) one or more poly (meth) acrylate compounds in a combined mass fraction from 35% to 85%; y) one or more polymerizable epoxy compounds in a combined mass fraction from 10% to 50%; and z) one or more photoinitiators in a combined mass fraction from 0.1% to 5%. Further, the carrier layer comprises a foam carrier, the foam carrier comprising one or more polyolefins.

According to a second aspect of the disclosure, a method for connecting two or more components with a reactive pressure-sensitive adhesive element is provided that includes: (a) providing the reactive pressure-sensitive adhesive element of the first aspect of the disclosure; (b) initiating a curing of the first UV-curable pressure-sensitive adhesive by activating the one or more photoinitiators in the first UV-curable pressure-sensitive adhesive by UV radiation; (c) initiating a curing of the second UV-curable pressure-sensitive adhesive by activating the one or more photoinitiators in the second UV-curable pressure-sensitive adhesive by UV radiation; and (d) connecting a first component and a second component to the reactive pressure-sensitive adhesive element to define a bonded substrate, wherein the connecting further comprises curing the first UV-curable pressure-sensitive adhesive and the second UV-curable pressure-sensitive adhesive.

According to a third aspect of the disclosure, a reactive pressure-sensitive adhesive clement is provided that includes: i) a carrier layer; ii) a first adhesive layer arranged on a first surface of the carrier layer, wherein the first adhesive layer comprises a first UV-curable pressure-sensitive adhesive; and iii) a second adhesive layer arranged on a second surface of the carrier layer facing away from the first surface of the carrier layer and the first adhesive layer, wherein the second adhesive layer comprises a second UV-curable pressure-sensitive adhesive. Each of the first UV-curable pressure-sensitive adhesive and the second UV-curable pressure-sensitive adhesive, based on a mass of the respective pressure-sensitive adhesive, comprises: x) one or more poly (meth) acrylate compounds in a combined mass fraction from 35% to 85%; y) one or more polymerizable epoxy compounds in a combined mass fraction from 10% to 50%; and z) one or more photoinitiators in a combined mass fraction from 0.1% to 5%. Further, the carrier layer comprises a foam carrier.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

Further details and features of the present invention are apparent from the description of figures and working examples. Here, the respective features may be realized on their own or as two or more in combination with one another. The invention is not confined to the working examples. The working examples are represented schematically in the figures. Identical reference numerals in the individual figures here denote identical or functionally identical elements or elements which correspond to one another in terms of their functions.

FIG. 1 shows a simplified schematic cross-sectional representation of a reactive pressure-sensitive adhesive element, according to a preferred embodiment; and

FIG. 2 shows a simplified schematic cross-sectional representation of a bonded substrate, according to an embodiment of the disclosure, when separating the bonded portion of the bonded substrate with a cutting tool.

### DETAILED DESCRIPTION

In the following detailed description, for purposes of explanation and not limitation, example embodiments disclosing specific details are set forth to provide a thorough understanding of various principles of the adhesive element of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or description that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise. The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

The invention, moreover, embraces all the features which are subjects of any dependent claims. Further, the invention embraces combinations of individual features with one another, including at different preference levels. The invention thus embraces, for example, the combination of a first feature identified as being “preferred” with a second feature identified as being “particularly preferred”. In this context, subjects identified as part of “embodiments”, likewise at different preference levels, are also embraced.

The inventors of the present invention have now found that the above-described objects can be achieved if a double-sided reactive pressure-sensitive adhesive element is provided in which the adhesive layers each have a UV-curable pressure-sensitive adhesive based on poly (meth) acrylate compounds and epoxy compounds, if a polyolefin foam as defined in the claims is used in the carrier layer of the reactive pressure-sensitive adhesive element.

Appropriate reactive pressure-sensitive adhesive elements advantageously have an advantageous pressure-sensitive adhesiveness in combination with a favorable interfacial adhesion between the specific selected foam carrier and the pressure-sensitive adhesive compound tailored chemically to it. The corresponding reactive pressure-sensitive adhesive elements can be quickly and reliably cured thanks to the UV-curability and they show excellent bonding performance. By combining the specific pressure-sensitive adhesives with the polyolefin foam, a bonded assembly is obtained after curing that has excellent mechanical properties, which support the advantageous longevity of the bond generated.

In a synergistic way, corresponding reactive pressure-sensitive adhesive elements open a way to a simple and efficient separation of the bond despite these advantageous technical adhesive properties. The cured reactive pressure-sensitive adhesive elements can be particularly easily and reliably separated or split along the carrier layer owing to the specific design of the carrier layer, in order to mechanically separate the bond generated. In this case, the corresponding reactive pressure-sensitive adhesive elements achieve an advantageous degree of separability, which according to the inventors' assessment cannot be achieved with the reactive pressure-sensitive adhesive elements known from the prior art. In other words, the efficient mechanical separation of already bonded components for the purpose of recycling or of replacing defective components, which is made possible by the corresponding reactive pressure-sensitive adhesive elements, is a particularly great advantage of the corresponding reactive pressure-sensitive adhesive elements.

Owing to the corresponding property profile, the corresponding reactive pressure-sensitive adhesive elements are particularly suitable for use in the electronics industry, e.g., for bonding displays in housings, as is done, for example, in the manufacture of mobile terminals.

The above-stated problems are thus solved by the subject-matter of the invention as defined in the claims. Preferred embodiments according to the invention result from the dependent claims and the observations below. Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred methods, bonded substrates and uses result from the features of preferred reactive pressure-sensitive adhesive tapes.

Insofar as below, for an element, e.g., the poly (meth) acrylate compounds or the foam carrier, both specific amounts or fractions of this element and preferred configurations of the element are disclosed. The disclosure also covers the specific amounts or fractions of the preferably configured elements. In addition, it is disclosed that with the corresponding specific total amounts or total fractions of the elements, at least a part of the elements can be preferably configured and also that preferably configured elements within the specific total amounts or total fractions may in turn be present in the specific amounts or fractions.

The invention relates to a reactive pressure-sensitive adhesive element comprising:
i) a carrier layer;
ii) a first adhesive layer arranged on the carrier layer, where the first adhesive layer comprises a first UV-curable pressure-sensitive adhesive; and
iii) a second adhesive layer arranged on the side of the carrier layer facing away from the first adhesive layer, where the second adhesive layer comprises a second UV-curable pressure-sensitive adhesive,

where the first UV-curable pressure-sensitive adhesive and the second UV-curable pressure-sensitive adhesive independently of each other, based on the mass of the respective pressure-sensitive adhesive, comprise:
x) one or more poly (meth) acrylate compounds in a combined mass fraction in the range from 35% to 85%,
y) one or more polymerizable epoxy compounds in a combined mass fraction in the range from 10% to 50%, and
z) one or more photoinitiators in a combined mass fraction in the range from 0.1% to 5%, where the carrier layer comprises a foam carrier, where the foam carrier comprises one or more polyolefins.

The reactive pressure-sensitive adhesive elements of the invention are particularly suitable for the bonding of components of electronic components.

The above designation as a pressure-sensitive adhesive element expresses how the shape of corresponding reactive pressure-sensitive adhesive elements of the invention can be freely chosen in principle, so that, for example, double-sided pressure-sensitive adhesive elements in the form of die-cuts are also conceivable. However, reactive pressure-sensitive adhesive tapes are of particular relevance in practice. Correspondingly, a reactive pressure-sensitive adhesive element of the invention is also preferred where the reactive pressure-sensitive adhesive element is a pressure-sensitive adhesive tape.

The term “pressure-sensitive adhesive tape” is clear to the person skilled in the field of adhesive technology. In the context of the present invention, the expression “tape” refers to all thin, elongated and planar structures, i.e., structures with a predominant extent in two dimensions with extended length and limited width, and to corresponding tape portions.

The reactive pressure-sensitive adhesive element of the invention comprises a carrier layer which is covered on both sides by adhesive layers in the manner of a double-sided adhesive tape. For improving the handling properties, suitable release layers-for example, release liners made of siliconized PET films-can also be arranged on the two adhesive layers, whereby storage in the form of rolls is facilitated in particular. In this case, it is a reactive pressure-sensitive adhesive element of the invention where the reactive pressure-sensitive adhesive element additionally comprises:
iv) a first release layer arranged on the first pressure-sensitive adhesive layer, preferably a release layer of polyester, more particularly polyethylene terephthalate (PET), where the release layer preferably has a release coating; and/or
v) a second release layer arranged on the second pressure-sensitive adhesive layer, preferably a release layer of polyester, more particularly polyethylene terephthalate, where the release layer preferably has a release coating.

Preferably, the reactive pressure-sensitive adhesive element of the invention consists of the constituents designated above.

The carrier layer usually refers to the layer of such a multilayer adhesive tape that significantly determines the mechanical and physical properties of the adhesive tape, such as the tear resistance, stretchability, insulation capacity or restoring capacity. Common materials known from the prior art for carrier layers of double-sided pressure-sensitive adhesive tapes are, for example, woven fabrics, laid scrims and plastic films, for example PET films.

In the context of the present invention, in contrast, a carrier layer is used which comprises a foam carrier, which in turn comprises one or more polyolefins. A foam, in accordance with the expert understanding, is a three-dimensional structure of gas-filled cells which are bounded by solid cell webs and which are present in a fraction such that the density of the foam in relation to the density of the matrix material-that is, the entirety of non-gaseous materials of which the material is composed-is reduced, preferably by 30% or more, particularly preferably by 50% or more.

The combination of the foam structure with the specific selection of the polyolefins as material in conjunction with the specific pressure-sensitive adhesives has surprisingly proven to be particularly advantageous. According to the inventors' assessment, the use of a polyolefin foam in the carrier layer results in a reactive pressure-sensitive adhesive element which after curing results in a bond having advantageous mechanical properties. Without wanting to be bound by this theory, the inventors assume that this is at least partly due to the damping of mechanical loads that can be achieved by the foam carrier. Advantageously, very advantageous bond strengths at the interface of the foam are manifested with the specific pressure-sensitive adhesives of the present inventions.

A particularly great advantage, however, is the surprising finding that the use of the specific foam carrier allows the cured reactive adhesive element to be separated through the foam carrier, i.e., orthogonally to the direction of thickness of the adhesive element or to the axis of connection between the bonded components or parallel to the surface extent of the reactive adhesive element, in order to undo the previously generated structural bond. This advantageous possibility, which according to the inventors' assessment does not exist in the same manner with other carrier layers, which do not comprise a foam carrier, can be used, for example, by a cutting tool in the form of a blade or a wire, preferably a wire, and allows the previously bonded components to be separated quickly and efficiently from each other, in order for example to recycle them separately from each other.

The skilled person understands that, at least theoretically, the carrier layer may include other constituents in addition to the foam carrier. For example, the carrier layer may have a multi-ply construction, where, for example, a connecting ply is provided between two foam carriers. However, particularly preferred with regard to efficient production and an advantageous performance profile is the use of a carrier layer which is predominantly, preferably substantially completely, formed of the foam carrier. Preferred in other words is a reactive pressure-sensitive adhesive element of the invention where the carrier layer consists of the foam carrier.

The foam carrier to be used according to the invention is a foam, more precisely a plastic foam, the foam structure of which accordingly consists of plastic. This plastic is specified in the context of the present invention in that the foam carrier in the foam material must include one or more polyolefins, for example polyethylene, since corresponding polyolefins have proven essential for the achievement of the advantages according to the invention, in particular in contrast to other plastic foams made of, for example, polyacrylates or polyurethanes.

The skilled person understands that in principle, further (co-) polymers may also be present in the plastic material, which may be blended with the polyolefins, or that the foamed plastic comprises additives with which the properties of the plastic can be specifically adjusted to the application requirements. However, in the light of the identified advantageous correlation between the polyolefins in the foam carrier and the specific pressure-sensitive adhesives, the skilled person understands that it is preferable to form the foam carrier at least predominantly, preferably very predominantly, in particular preferably substantially completely from polyolefins. Accordingly, a reactive adhesive pressure-sensitive element of the invention is preferred where the foam carrier consists to a mass fraction of 80% or more, preferably of 90% or more, particularly preferably of 95% or more, very particularly preferably of 98% or more, preferably substantially completely, of the one or the two or more polyolefins, based on the mass of the foam carrier.

According to the inventors' assessment, all industrially relevant polyolefins are in principle suitable for the foam carrier, since they are in principle similar in terms of many relevant properties, especially the polarity of the polymers. However, the inventors have succeeded in identifying particularly suitable polyolefins for the foam carrier, with which a particularly advantageous performance profile is obtained in practice; in the opinion of the inventors, polyethylene foam carriers in particular result in particularly advantageous reactive pressure-sensitive adhesive elements of the invention. Preferable, indeed, is a reactive pressure-sensitive adhesive element of the invention where the one or the two or more polyolefins are selected from the group consisting of polyethylene, polypropylene, polyisobutylene, polybutylene and polymethylpentene, preferably selected from the group consisting of polyethylene and polypropylene, particularly preferably polyethylene, where the foam carrier particularly preferably consists of polyethylene.

Even if the inventors estimate that, in principle, acceptable results can also be achieved with open-pored foams, the inventors consider the use of closed-pored foams to be advantageous. Accordingly, a reactive pressure-sensitive adhesive element of the invention is preferred where the foam carrier is a closed-pored foam.

The inventors have succeeded in identifying a degree of foaming for the foam carrier with which in particular an advantageous separability can be obtained. A reactive pressure-sensitive adhesive element according to the invention is preferred, indeed, where the foam carrier has a density in the range from 200 to 600 kg/m³, preferably in the range from 250 to 550 kg/m³, particularly preferably in the range from 300 to 500 kg/m³, very particularly preferably in the range from 350 to 450 kg/m³. In addition, or alternatively, a reactive pressure-sensitive adhesive element of the invention is also preferred where the foam carrier has a surface weight in the range from 50 to 250 g/m², preferably in the range from 80 to 200 g/m², particularly preferably in the range from 100 to 150 g/m².

A parameter by which, according to the inventors' assessment, foam carriers can be characterized that are particularly suitable for processing with mechanical cutting tools, for example cutting knives, and show, after bonding, an advantageous damping behavior which is suitable particularly for the bonding of displays, is the compressive strength of the foam carrier. Preferred is a reactive pressure-sensitive adhesive element of the invention where the foam carrier has a compressive strength in the range from 300 to 900 kPa, preferably in the range from 350 to 850 kPa, particularly preferably in the range from 450 to 750 kPa, very particularly preferably in the range from 550 to 650 kPa, determined according to DIN 53577-1988-12, preferably at a deformation of 25%. According to the inventors' assessment, suitable compressive strengths also result in particularly advantageous separability of the resulting bond and thus in reactive pressure-sensitive adhesive elements which when used in bonded substrates result in the substrates being recyclable particularly efficiently at the end of their life.

On the carrier layer, preferably directly on the foam carrier, an adhesive layer is arranged on each side. These adhesive layers each comprise a pressure-sensitive adhesive which gives the reactive pressure-sensitive adhesive element the pressure-sensitive adhesiveness. A pressure-sensitive adhesive, in accordance with the expert understanding, is an adhesive which has pressure-sensitive adhesive properties, i.c., the property of making a permanent connection to an adhesion base even under relatively low applied pressure. Corresponding pressure-sensitive adhesive tapes are usually detachable from the adhesion base again after use, essentially free of residue, and are usually permanently self-adhesive even at room temperature, which means that they have a certain viscosity and touch-stickiness, so that they wet the surface of a substrate even at low applied pressure. The degree of pressure-sensitive adhesiveness of a pressure-sensitive adhesive tape of the disclosure depends on the pressure-sensitive adhesive selected as the adhesive for the tape. Without wanting to be bound to this theory, it is often assumed that a pressure-sensitive adhesive can be considered as an extremely high-viscosity fluid with an elastic component, which consequently has characteristic viscoelastic properties, which lead to the above-described permanent self-adhesiveness and pressure-sensitive bondability. It is assumed that with corresponding pressure-sensitive adhesive compounds, mechanical deformation results both in viscous flow processes and in the build-up of elastic restoring forces. The proportional viscous flow is used to achieve adhesion, while the proportional elastic restoring forces are particularly necessary for achieving cohesion. The relationships between rheology and pressure-sensitive adhesiveness are known in the art and are described, for example, in D. Satas, “Handbook of Pressure Sensitive Adhesives Technology”, 3rd edition (1999), pp. 153 to 203. The storage modulus (G′) and the loss modulus (G″), which can be determined by means of dynamic mechanical analysis (DMA), for example by using a rheometer, as disclosed, for example, in WO 2015/189323 A1, are usually used to characterize the measure of elastic and viscous components. In the context of the present invention, an adhesive is preferably understood as being pressure-sensitively adhesive and thus as a pressure-sensitive adhesive when at a temperature of 23° C. in the deformation frequency range from 10⁰ to 10¹ rad/sec, G′ and G″ are each at least in part in the range from 10³ to 10⁷ Pa.

The skilled person understands that in addition to the pressure-sensitive adhesive, the adhesive layers may, at least in principle, also comprise other constituents, with particular candidates including fillers for adjusting the mechanical properties, as disclosed below. In this respect, however, it is preferred for substantially all embodiments if the adhesive layers consist as largely as possible of the corresponding pressure-sensitive adhesives. For substantially all embodiments, a reactive pressure-sensitive adhesive element of the invention is accordingly preferred where the first pressure-sensitive adhesive layer consists to a mass fraction of 80% or more, preferably of 90% or more, particularly preferably of 95% or more, very particularly preferably of 98% or more, in particular preferably substantially completely, of the first UV-curable pressure-sensitive adhesive. For substantially all embodiments additionally or alternatively, preferably additionally, a reactive pressure-sensitive adhesive element of the invention is preferred where the second pressure-sensitive adhesive layer consists to a mass fraction of 80% or more, preferably of 90% or more, particularly preferably of 95% or more, very particularly preferably of 98% or more, in particular preferably substantially completely, of the second UV-curable pressure-sensitive adhesive, where in particular preferably for both adhesive layers of the adhesives the same lower limits of the mass fractions are set.

The pressure-sensitive adhesives used in the first and second adhesive layers are UV-curable pressure-sensitive adhesives. This means that the UV-curable pressure-sensitive adhesives used are adhesives which are curable by the radiation emitted by a UV radiation source, e.g., a UV-LED, or constitute an adhesive in which UV-radiation-based activation leads to a crosslinking of the constituents of the pressure-sensitive adhesive. Owing to the possibility for curing, the curable adhesive can preferably act as a structural adhesive after curing. According to DIN EN 923: 2016-03, structural adhesives are demonstrably suitable for load-bearing constructions in which the adhesive bond can be stressed over long periods with a high percentage of the maximum breaking force without failure (according to the ASTM definition: “bonding agents used for transferring required loads between adherends exposed to service environments typical for the structure involved”). They are therefore adhesives for highly chemically and physically stressable adhesives that contribute to the strengthening of the adhesive tapes in the cured state. Preferably, the UV-curable pressure-sensitive adhesives are curable by irradiation with electromagnetic radiation having a wavelength in the range from 100 to 400 nm, preferably in the range from 200 to 390 nm, particularly preferably in the range from 300 to 380 nm, in particular, in the range from 350 to 370 nm. Radiation-induced curing at room temperature has the advantage for bonding that it is suitable for efficiently assembling temperature-sensitive components with different coefficients of expansion with little effort and energy input.

UV-curable adhesives and the underlying physical-chemical relationships are fundamentally known to the skilled person in the field of adhesive technology. The UV-curability of the UV-curable pressure-sensitive adhesives for use according to the invention is ensured in the present case by the use of polymerizable compounds in combination with a corresponding photoinitiator.

The UV-curable pressure-sensitive adhesives are defined within the scope of the present invention by way of the respective constituents and their mass fractions. These constituents are each used as “one or more” in accordance with the expert understanding. The term “one or more” refers here, in the manner usual in the sector, to the chemical nature of the compounds in question and not to the amount of substance thereof. For example, the UV-curable pressure-sensitive adhesive can comprise as a polymerizable epoxy compound only a certain type of diglycidyl ether, which would mean the UV-curable pressure-sensitive adhesive compound comprises a plurality of the corresponding molecules.

In a customary manner, the mass fractions are expressed as combined mass fractions of the one or more components, where the mass fraction of the correspondingly formed components taken together meets the corresponding criteria, with in each case, unless otherwise specified, the mass of the curable adhesive being the reference system.

The skilled person understands that the reactive pressure-sensitive adhesive element can in principle also be coated with different pressure-sensitive adhesives on both sides. Accordingly, the first UV-curable pressure-sensitive adhesive and the second UV-curable pressure-sensitive adhesive are in principle independent of each other in terms of their composition. However, it is particularly preferred from a manufacturing point of view if the first adhesive layer and the second adhesive layer, or the respective pressure-sensitive adhesives, are substantially identical. Preferred accordingly is a reactive pressure-sensitive adhesive element of the invention where the first UV-curable pressure-sensitive adhesive and the second UV-curable pressure-sensitive adhesive are identical.

The inventors of the present invention have succeeded in identifying particularly preferred ranges for the mass fractions of the components used, with which particularly advantageous technical adhesive properties can be realized. In this case, it is preferred if corresponding ranges are set for the first UV-curable pressure-sensitive adhesive and the second UV-curable pressure-sensitive adhesive. Preferred against this background is a reactive pressure-sensitive adhesive element of the invention wherein the first UV-curable pressure-sensitive adhesive and the second UV-curable pressure-sensitive adhesive independently of each other, based on the mass of the respective pressure-sensitive adhesive, comprise:

x.b) one or more poly (meth) acrylate compounds in a combined mass fraction in the range from 45% to 80%, preferably in the range from 50% to 80%, particularly preferably in the range from 55% to 75%, most preferably in the range from 60% to 70%;

y.b) one or more polymerizable epoxy compounds in a combined mass fraction in the range from 15% to 45%, preferably in the range from 20% to 40%, particularly preferably in the range from 25% to 35%; and/or

z.b) one or more photoinitiators in a combined mass fraction in the range from 0.2% to 2%, preferably in the range from 0.3% to 1%.

In addition to the above constituents, further constituents can be used in the UV-curable pressure-sensitive adhesives, whereby the physical-chemical properties of the UV-curable pressure-sensitive adhesives can be advantageously adjusted. An example is a reactive pressure-sensitive adhesive element of the invention wherein the first UV-curable pressure-sensitive adhesive and the second UV-curable pressure-sensitive adhesive independently of each other, based on the mass of the respective pressure-sensitive adhesive, comprise:

u) one or more tackifier resins in a combined mass fraction in the range from 1% to 25%, preferably in the range from 2% to 20%, particularly preferably in the range from 5% to 15%;

v) one or more open-time additives in a combined mass fraction in the range from 0.1% to 5%, preferably in the range from 0.2% to 2%; the one or the two or more open-time additives are ether compounds, preferably selected from the group consisting of polyols and crown ethers; and/or

w) one or more further additives in a combined mass fraction in the range from 0.1% to 25%, preferably in the range from 0.2% to 20%, particularly preferably in the range from 0.5% to 15%, the further additives being preferably selected from the group consisting of anchoring additives, aging inhibitors, light stabilizers, UV absorbers, rheological additives, dyes and pigments.

Particularly suitable UV-curable pressure-sensitive adhesives, which can be used as both the first and the second UV-curable pressure-sensitive adhesive, comprise, based on the mass of the UV-curable pressure-sensitive adhesive, in particular the following constituents:

vv) one or more open-time additives in a combined mass fraction in the range from 0.1% to 5%;

ww) one or more anchoring additives in a combined mass fraction in the range from 0.1% to 5%;

xx) one or more poly (meth) acrylate compounds in a combined mass fraction in the range from 35% to 85%;

yy) one or more polymerizable epoxy compounds in a combined mass fraction in the range from 10% to 50%; and

zz) one or more photoinitiators in a combined mass fraction in the range from 0.1% to 5%.

Although the UV-curable pressure-sensitive adhesives can comprise further constituents, it is preferred according to the inventors' assessment if the UV-curable pressure-sensitive adhesives consist as largely as possible of the constituents x.b), y.b) and z.b). Preferred for this purpose is a reactive pressure-sensitive adhesive element of the invention wherein the combined mass fraction of the poly (meth) acrylate compounds, the polymerizable epoxy compounds and the photoinitiators is 80% or more, preferably 90% or more, particularly preferably 95% or more, based on the mass of the respective UV-curable pressure-sensitive adhesive.

A special case of additives used to adjust the properties of pressure-sensitive adhesives are insoluble fillers that can be added to the pressure-sensitive adhesive to obtain a filled pressure-sensitive adhesive. These are particulate fillers with an average particle diameter (D50) of 5 μm or more, preferably 10 μm or more, particularly preferably 20 μm or more, which are not soluble in the pressure-sensitive adhesive and are present therein accordingly as a dispersion, and also, macroscopic fillers, such as fibers, for example. Preferably, the insoluble fillers are selected from the group consisting of particulate fillers. Particularly preferably, the insoluble fillers are selected from the group consisting of expandable polymer hollow spheres, non-expandable polymer hollow spheres, polymer solid spheres, glass hollow spheres, glass solid spheres, ceramic hollow spheres, ceramic solid spheres, mineral hollow spheres, mineral solid spheres and/or carbon solid spheres. However, insoluble fillers also include, for example, fibers, laid scrims, platelets and rodlets of materials insoluble in the pressure-sensitive adhesive. Owing to their in some cases already macroscopic dimensions and the lack of solubility, these essentially have no influence on the above-disclosed relationships of the compositional chemistry of the pressure-sensitive adhesive, but are instead present in a heterogeneous mixture with the pressure-sensitive adhesive. Accordingly, these insoluble fillers are not attributed to the pressure-sensitive adhesive within the scope of the present invention and are accordingly not considered in the calculation of mass fractions relative to the mass of the pressure-sensitive adhesive. In the context of the present invention, the definition is rather that the addition of insoluble fillers to a pressure-sensitive adhesive for use according to the invention results in a filled pressure-sensitive adhesive, i.e., a filled pressure-sensitive adhesive comprising:
p) a pressure-sensitive adhesive, preferably as disclosed as preferred above, and
q) one or more insoluble fillers.

Preferably, the combined mass fraction of the insoluble fillers is in the range from 1% to 50%, particularly preferably in the range from 2% to 40%, very particularly preferably in the range from 5% to 30%.

Curable adhesives are comprehensively known to the skilled person as described above from the prior art, where the individual components specified above are also known to the skilled person in isolation and are commercially available in different variations from numerous different suppliers, with preferred and exemplary representatives of the individual components being disclosed below.

The UV-curable pressure-sensitive adhesives in particular comprise one or more poly (meth) acrylate compounds, i.c., (co) polymers of (meth) acrylate compounds. In the context of the present invention, the expression “poly (meth) acrylate” in accordance with the skilled person's understanding embraces polyacrylates and polymethacrylates and also copolymers of these polymers. Poly (meth) acrylates may contain smaller amounts of monomer units that are not derived from (meth) acrylates. In the context of the present invention, a “poly (meth) acrylate” thus means a (co) polymer for which the monomer base consists to a mass fraction of 70% or more, preferably 90% or more, particularly preferably 98% or more, of monomers selected from the group consisting of acrylic acid, methacrylic acid, acrylic acid esters and methacrylic acid esters, based on the mass of the monomer base. Preferably, the mass fraction of acrylic acid esters and/or methacrylic acid esters is 50% or more, particularly preferably 70% or more. Poly (meth) acrylates are generally accessible by radical polymerization of acrylic-and/or methacrylic-based monomers and, optionally, other copolymerizable monomers.

The production of such poly (meth) acrylates from the respective monomers can be carried out according to the usual methods, including conventional radical polymerizations or controlled radical polymerizations, for example anionic polymerization, RAFT, NMRP or ATRP polymerization. The polymers or oligomers can be prepared by copolymerization of the monomeric components using the usual polymerization initiators and optionally chain transfer agents, where polymerization may be performed at the usual temperatures, for example, in bulk, in emulsion, e.g., in water or liquid hydrocarbons, or in solution. Preferably, the poly (meth) acrylates are prepared by polymerization in solvents, particularly preferably in solvents having a boiling temperature in the range from 50 to 150° C., particularly preferably in the range from 60 to 120° C., using the usual amounts of polymerization initiators, the polymerization initiators being added to the monomer composition generally in a fraction of about 0.01% to 5%, in particular from 0.1% to 2%, based on the mass of the monomer composition.

Suitable polymerization initiators are, for example, radical sources such as peroxides, hydroperoxides and azo compounds, e.g., dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, or benzopinacol. Particularly preferably, 2,2′-azobis (2-methylbutyronitrile) or 2,2′-azobis (2-methylpropionitrile) is used as the radical polymerization initiator. In particular, alcohols such as methanol, ethanol, n-and iso-propanol, n-and iso-butanol, preferably isopropanol and/or isobutanol, and also hydrocarbons such as toluene and in particular petroleum benzenes with a boiling temperature in the range from 60 to 120° C., may be used as solvents. In particular, ketones, such as acetone, methyl ethyl ketone and methyl isobutyl ketone, and esters, such as ethyl acetate, for example, and also mixtures of these solvents, may be used.

The poly (meth) acrylate compounds for use according to the invention can be prepared in other words by polymerization, in particular radical polymerization, of a monomer composition comprising one or more polymerizable (meth) acrylate compounds, preferably monofunctional (meth) acrylate compounds. In accordance with the expert understanding and the usual procedure in the field of technology, it is conducive to define polymeric compounds such as the poly (meth) acrylate compounds in this manner via the preparation process or the starting materials used for their preparation, since it is impossible to define the corresponding materials meaningfully in any different way. It is preferred accordingly that the combined mass fraction of the one or of the two or more polymerizable (meth) acrylate compounds in the monomer composition is 80% or more, preferably 90% or more, particularly preferably 95% or more, very particularly preferably 98% or more, based on the mass of the monomer composition.

The inventors have identified preferred degrees of polymerization that can be adjusted to obtain particularly advantageous properties. A pressure-sensitive adhesive is preferred, indeed, wherein the one or the two or more poly (meth) acrylate compounds have a weight-average molecular weight M_{w}, measured by means of GPC, of 300000 g/mol or more, preferably of 400000 g/mol or more, particularly preferably of 500000 g/mol or more. The weight-average molecular weight here is determined by gel permeation chromatography (GPC) on 100 mL of a clear-filtered sample (sample concentration 0.5 g/L). Tetrahydrofuran with 0.1% by volume of trifluoroacetic acid is used as the cluent. The measurement is carried out at 25° C. The guard column used is a PSS-SDV type column, 10 μm, ID 8.0 mm×50 mm. For separation, columns of the type PSS-SDV, 5 ×m, 10³ Å (SN9090201) and 5 μm, 10² Å (SN9090200) with ID 8.0 mm×300 mm each are used (detection by differential refractometer PSS-SECurity 1260 RID). The flow rate is 0.5 mL per minute. The calibration is against PMMA standards (polymethyl methacrylate calibration).

In the estimation of the inventors, essentially all poly (meth) acrylate compounds are suitable in principle for use in the (meth) acrylate matrix of the UV-curable pressure-sensitive adhesives. However, in their own experiments, the inventors have succeeded in identifying particularly suitable poly (meth) acrylate compounds with which particularly powerful reactive pressure-sensitive adhesive elements can be obtained, especially with regard to the peel adhesion and adhesion on the foam carrier. These preferred poly (meth) acrylate compounds can be defined by way of the monomer composition used for the preparation. A reactive pressure-sensitive adhesive element of the invention is preferred wherein the one or the two or more polymerizable (meth) acrylate compounds of the monomer composition are selected from the group consisting of monofunctional (meth) acrylates, preferably monofunctional acrylates, wherein the one or the two or more polymerizable (meth) acrylate compounds are preferably selected from the group consisting of methyl (meth) acrylate, butyl (meth) acrylate, and phenoxyethyl (meth) acrylate, preferably methyl acrylate, butyl acrylate and phenoxyethyl acrylate.

Preferred in addition or alternatively is a reactive pressure-sensitive adhesive element of the invention wherein the monomer composition comprises two or more, preferably three or more, polymerizable (meth) acrylate compounds.

In addition to the poly (meth) acrylate compounds, the UV-curable pressure-sensitive adhesives also comprise one or more polymerizable epoxy compounds. In accordance with the expert understanding, “epoxy compounds” are compounds that carry at least one oxirane group (also referred to as an epoxy group). For example, they may be of an aromatic, aliphatic or cycloaliphatic nature. Polymerizable epoxy compounds can comprise both monomeric and oligomeric or polymeric epoxy compounds, where the oligomeric or polymeric epoxy compounds are in particular oligomers or polymers of monomeric polymerizable epoxy compounds, and are also in some cases referred to as epoxy resins or reactive resins.

Polymerizable epoxy compounds often have on average at least two epoxy groups per molecule, preferably more than two epoxy groups per molecule. The expression “polymerizable” refers in accordance with the expert understanding to the ability of these compounds, where appropriate after suitable activation, to enter a polymerization reaction. Further, a “polymerization reaction” is a process wherein one or more monomer units combine chemically to produce larger polymer chains or networks. In the case of the polymerizable epoxy compounds, the polymerizability is made possible in particular by the epoxy groups. Preferred is a reactive pressure-sensitive adhesive element of the invention wherein the one or the two or more polymerizable epoxy compounds are selected from the group consisting of difunctional epoxy compounds.

With regard to the polymerizable epoxy compounds as well, the inventors have succeeded in identifying preferred compounds with which particularly powerful reactive pressure-sensitive adhesive elements can be obtained, in particular with regard to the peel adhesion, the adhesion on the foam carrier and the curing behavior. A reactive pressure-sensitive adhesive element of the invention is preferred, indeed, wherein the one or the two or more polymerizable epoxy compounds are selected from the group consisting of aromatic and cycloaliphatic epoxy compounds, where the one or the two or more polymerizable epoxy compounds are preferably selected from the group consisting of 3,4-epoxycycyclohexylmethyl 3,4-epoxyclohexanecarboxylate and diglycidyl ethers, in particular bisphenol A epichlorhydrin resin, and also oligomers of these compounds.

According to the inventors' knowledge, particularly preferred pressure-sensitive adhesives are obtained when epoxy compounds are combined with each other. A reactive pressure-sensitive adhesive element of the invention is preferred, indeed, wherein the first UV-curable pressure-sensitive adhesive and the second UV-curable pressure-sensitive adhesive independently of each other comprise two or more, preferably three or more, polymerizable epoxy compounds.

In principle, all photoinitiators known to the skilled person from the prior art for this purpose can be used as photoinitiators. The skilled person selects, for example, one or more compounds from among the commercially available photoinitiators, optionally in combination with sensitizers or other additives, which match their target applications properties, with the skilled person adapting the activation wavelength of the photoinitiators or photoinitiator system to the desired wavelength.

The inventors have found in their own experiments that the dimensioning of the reactive pressure-sensitive adhesive tape has an influence on the technical adhesive properties. In this respect, the inventors have found that the thickness of the foam carrier, i.c., the extent orthogonal to the flat extent of the adhesive element, should not be chosen too large. It has also been identified as advantageous when the adhesive layers have a lower combined thickness than the carrier layer, or than the foam carrier, if the latter in a preferred manner essentially forms the carrier layer. Together with the thicknesses of the adhesive layers identified as favorable, this results in a preferred thickness range for the overall thickness.

Preferred is a reactive pressure-sensitive adhesive element of the invention wherein the carrier layer and/or the foam carrier, in particular both the carrier layer and the foam carrier, have a mean thickness in the range from 150 to 550 μm, preferably in the range from 200 to 500 μm, particularly preferably in the range from 250 to 460 μm, very particularly preferably in the range from 280 to 420 μm.

Preferred, in addition or alternatively, is a reactive pressure-sensitive adhesive element of the invention wherein the first pressure-sensitive adhesive layer and/or the second pressure-sensitive adhesive layer have a mean thickness in the range from 20 to 80 μm, preferably in the range from 30 to 70 μm, particularly preferably in the range from 40 to 60 μm, very particularly preferably in the range from 45 to 55 μm. Preferred, likewise in addition or alternatively, is a reactive pressure-sensitive adhesive element of the invention wherein the first pressure-sensitive adhesive layer and the second pressure-sensitive adhesive layer differ in terms of the mean thickness by less than 20%, preferably less than 10%, very particularly preferably less than 5%, in particular preferably less than 1%. Preferred in turn, in addition or alternatively, is a reactive pressure-sensitive adhesive element of the invention wherein the reactive pressure-sensitive adhesive element has a mean thickness in the range from 200 to 600 μm, preferably in the range from 250 to 550 μm, particularly preferably in the range from 300 to 500 μm, very particularly preferably in the range from 350 to 450 μm. Particularly preferred additionally or alternatively is a reactive pressure-sensitive adhesive element of the invention wherein the ratio of the combined mean thickness of the first pressure-sensitive adhesive layer and of the second pressure-sensitive adhesive layer divided by the mean thickness of the carrier layer or of the foam carrier, preferably of both the carrier layer and the foam carrier, is in the range from 0.15 to 0.6, preferably in the range from 0.2 to 0.5, particularly preferably in the range from 0.25 to 0.4. Reactive pressure-sensitive adhesive tapes of the invention can be produced in an advantageous manner particularly efficiently and using methods established in the field of technology. In particular, the inventors propose that the adhesive layers can first be shaped by means of solvent coating on a liner, which may be, for example, a liner which later acts as a release layer in the reactive pressure-sensitive adhesive element of the invention. The adhesive layer here is obtained by drying at elevated temperatures, for example at 100° C. The adhesive layers thus produced can then be laminated on both sides onto the surface of the foam carrier in order to form the reactive pressure-sensitive adhesive tape of the invention. This has the advantage that the use of more temperature-sensitive foams, for example made of polyethylene, is also possible efficiently and without loss of performance.

The invention also relates to a method for connecting two or more components for attaching a display to a housing, with a reactive pressure-sensitive adhesive element of the invention, comprising the method steps of:
a) producing or providing a reactive pressure-sensitive adhesive element of the invention;
b) initiating the curing of the first UV-curable pressure-sensitive adhesive by activating the one or more photoinitiators in the first UV-curable adhesive by means of UV radiation;
c) initiating the curing of the second UV-curable pressure-sensitive adhesive by activating the one or more photoinitiators in the second UV-curable pressure-sensitive adhesive by means of UV radiation; and
d) connecting a first component and a second component to the reactive pressure-sensitive adhesive tape with curing of the first UV-curable pressure-sensitive adhesive and the second UV-curable pressure-sensitive adhesive to give a bonded substrate.

A method according to the invention is preferred wherein the first component is a housing for an electronic device, and/or wherein the second component is a display for an electronic device.

Finally, the use of a reactive pressure-sensitive adhesive element of the invention is also disclosed, in the bonding of two or more components by curing the first UV-curable pressure-sensitive adhesive and the second UV-curable pressure-sensitive adhesive to generate a mechanically robust cohesive connection with improved mechanical damping properties and improving the separability of the cured reactive adhesive pressure-sensitive element orthogonally to the thickness direction.

The invention also relates to a bonded substrate, e.g., an electronic terminal device, produced or producible by the method according to the invention or by the disclosed use, comprising at least between a first component and a second component, preferably between a housing and a display arranged in the housing, a bonded assembly comprising:
i.1 a first cured adhesive layer cohesively connected to the first component, produced or producible by curing the first UV-curable pressure-sensitive adhesive;
ii.2 a second cured adhesive layer cohesively connected to the second component, produced or producible by curing the second UV-curable pressure-sensitive adhesive; and
iii.3 a carrier layer cohesively connected to the first cured adhesive layer and the second cured adhesive layer, where the carrier layer comprises a foam carrier, where the foam carrier comprises one or more polyolefins.

Corresponding bonded substrates can be produced using reactive pressure-sensitive adhesive tapes of the invention by the method according to the invention and have an advantageously resistant bond between the components. By the arrangement of the damping layer of the foam carrier between the two cured adhesive layers produced by curing, advantageous mechanical properties of the bond are achieved, which contribute synergistically to a long durability of the bond.

The invention also relates to a method for separating a bonded substrate of the invention, comprising the method step of:
a) mechanically separating the bond of the bonded substrate along the carrier layer, where the mechanical separation of the bonding is preferably done with a separating tool, particularly preferably with a wire.

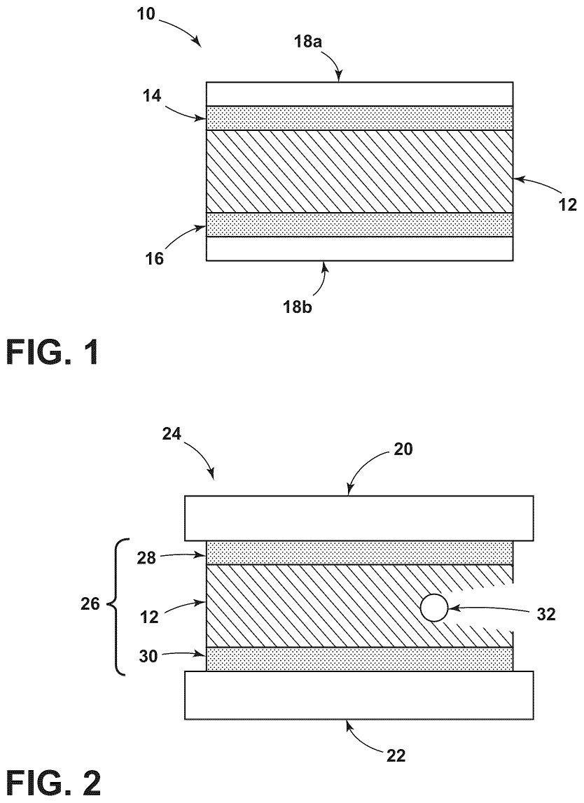

Referring now to FIG. 1, the figure shows a simplified schematic cross-sectional representation through a reactive pressure-sensitive adhesive element 10, according to a preferred embodiment. This reactive pressure-sensitive adhesive element 10 comprises a carrier layer 12, which is completely formed of a polyethylene foam in the example shown. The polyethylene foam carrier (e.g., carrier layer 12) has a mean thickness of about 300 μm, a surface weight of about 120 g/m², a density of about 400 kg/m³, and a compressive strength of about 590 kPa.

As also shown in FIG. 1, a first adhesive layer 14 and a second adhesive layer 16 are arranged on the opposing surfaces of the carrier layer 12, each of which is covered with a release layer 18a, 18b, respectively, of PET (50 μm thickness for upper release layer 18a and 75 μm thickness for lower release layer 18b). The first adhesive layer 14 and the second adhesive layer 16 in the example shown in FIG. 1 are essentially identical adhesive layers with a mean thickness of 50 μm each, each consisting entirely of the same UV-curable pressure-sensitive adhesive. Further, in the example of FIG. 1, an advantageous UV-curable pressure-sensitive adhesive is used as the UV-curable pressure-sensitive adhesive for the adhesive layers 12, 14, and shows excellent adhesion on the specific foam carrier (e.g., carrier layer 12), especially at elevated temperatures of, for example, 70° C. In combination with the foam carrier (e.g., carrier layer 12), the advantageous UV-curable pressure-sensitive adhesive results in a reactive pressure-sensitive adhesive element 10 that can be bonded to a substrate (not shown, upon removal of release layers 18a, 18b), and then removed from the substrate substantially without residues as and when required (not shown).

As shown in FIG. 2, by the curing of the UV-curable adhesives of the first adhesive layer 14 and the second adhesive layer 16 of the reactive pressure-sensitive adhesive element 10 (see FIG. 1, after removal of release layers 18a, 18b) when connecting a first component 20 and a second component 22 of a bonded substrate 24, a strong and long-lived bonded assembly 26 can be obtained. In the bonded substrate 24, the first adhesive layer 14 and second adhesive layer 16 are converted to first and second cured adhesive layers 28, 30, respectively. Further, the bonded assembly 26, at the end of the life of the bonded substrate 24, can be separated in an efficient manner with a separating tool 32, for example a wire. For example, the separating tool 32 can be moved through the carrier layer 12 arranged between the first cured adhesive layer 28 and the second cured adhesive layer 30, to separate the components 20, 22 of the bonded substrate 24 again.

### EXAMPLE

The following example represents a non-limiting example of the reactive pressure-sensitive elements of the disclosure, including the methods of making them. In this example, the corresponding UV-curable pressure-sensitive adhesive comprises (in parts by weight):

70 parts of polymethacrylate prepared by polymerization of a monomer composition consisting by mass of around 51% butyl acrylate, 39.5% methyl acrylate, 9.5% epoxycyclohexylmethyl methacrylate;

5 parts of distilled difunctional bisphenolA/epichlorohydrin liquid epoxide with a weight per epoxy of 185 to 192 g/eq, with a viscosity at 25° C. of 10 to 12 Pa*s (trade name: Epikote 828 LVEL, company: Hexion);

14 parts of solid bisphenol A-based epoxy resin with a softening temperature of 82-90° C. (Trade name: Araldite GT 7072, company: Huntsman);

10 parts of 3,4-epoxycycyclohexylmethyl 3,4-epoxycyclohexanecarboxylate; CAS 2386-87-0, liquid cycloaliphatic diepoxy having a melting point of −37° C. and a viscosity at 23°° C. of 0.25 Pa*s (trade name: Uvacure 1500, company: Dow); and

1.5 parts of triarylsulfonium hexafluorophosphate, mixed salts 50% in propylene carbonate.

The UV-curable pressure-sensitive adhesive and the corresponding adhesive layers were produced according to the methods of the disclosure, along with the analogous methods disclosed in International Patent Publication No. WO 2023274875 A1, the salient portions of which are hereby incorporated by reference in this disclosure. The resulting reactive pressure-sensitive element (e.g., as indicative of the reactive pressure-sensitive adhesive element 10) was then laminated onto the polyethylene foam.

The technical adhesive properties obtained for the reactive pressure-sensitive element of this example (e.g., as indicative of the reactive pressure-sensitive adhesive element 10) include the results from a static shear test according to ASTM D3654M-06 (2019), as measured for different foam carriers, each coated on both sides with a pressure-sensitive adhesive of the above composition, the mean thickness of the two adhesive layers being about 50 μm for each layer. In the static shear test according to ASTM D3654M-06 of this example, two test substrates made of steel were bonded with the reactive pressure-sensitive adhesive element of this example and loaded in shear by means of a weight (50 N/312.5 mm). The test was carried out at 70° C. and the holding time (max. 30000 min) to failure was recorded in minutes, along with evaluation of the fracture mode where appropriate. The results of the static shear test of this example are summarized in Table 1 below.

TABLE 1

| | Foam carrier | | Static shear test at 70° C. | |
|---|---|---|---|---|
| | | Thickness/ | Holding | |
| No. | Material | μm | time/min. | Fracture mode |
| 1 | Polyethylene | 300 | >30000 | Adhesive fracture to steel |
| | | | | substrate |
| 2 | Polyurethane | 300 | <1 | Anchoring fracture to foam |
| 3 | Polyurethane | 300 | <1 | Anchoring fracture to foam |
| 4 | Polyurethane | 790 | <1 | Anchoring fracture to foam |
| 5 | Acrylate | 200 | 4 | Anchoring fracture to foam |
| 6 | Acrylate | 400 | 2 | Anchoring fracture to foam |
| 7 | Acrylate | 100 | 17 | Anchoring fracture to foam |

The results in Table 1 above illustrate the surprising suitability of the pressure-sensitive adhesive of the disclosure for inventive use for polyolefin foams, in particular polyethylene foam, and illustrate the advantageous technical adhesive properties of reactive pressure-sensitive adhesive tapes and elements of the invention.

The following is a list of reference symbols employed in FIGS. 1 and 2:
10 reactive pressure-sensitive adhesive element;
12 carrier layer;
14 first adhesive layer;
16 second adhesive layer;
18a upper release layer;
18b lower release layer;
20 first component;
22 second component;
24 bonded substrate;
26 bonded assembly;
28 first cured adhesive layer;
30 second cured adhesive layer; and
32 separating tool.

Embodiment 1. According to Embodiment 1, a reactive pressure-sensitive adhesive element is provided that includes: i) a carrier layer; ii) a first adhesive layer arranged on a first surface of the carrier layer, wherein the first adhesive layer comprises a first UV-curable pressure-sensitive adhesive; and iii) a second adhesive layer arranged on a second surface of the carrier layer facing away from the first surface of the carrier layer and the first adhesive layer, wherein the second adhesive layer comprises a second UV-curable pressure-sensitive adhesive. Each of the first UV-curable pressure-sensitive adhesive and the second UV-curable pressure-sensitive adhesive, based on a mass of the respective pressure-sensitive adhesive, comprises: x) one or more poly (meth) acrylate compounds in a combined mass fraction from 35% to 85%; y) one or more polymerizable epoxy compounds in a combined mass fraction from 10% to 50%; and z) one or more photoinitiators in a combined mass fraction from 0.1% to 5%. Further, the carrier layer comprises a foam carrier, the foam carrier comprising one or more polyolefins.

Embodiment 2. According to Embodiment 2, the adhesive element of Embodiment 1 is provided, wherein the one or more polyolefins are selected from the group consisting of polyethylene, polypropylene, polyisobutylene, polybutylene and polymethylpentene.

Embodiment 3. According to Embodiment 3, the adhesive element of Embodiment 1 is provided, wherein the one or more polyolefins are polyethylene.

Embodiment 4. According to Embodiment 4, the adhesive element of Embodiment 1 is provided, wherein the foam carrier has a density from 200 to 600 kg/m³.

Embodiment 5. According to Embodiment 5, the adhesive element of Embodiment 1 is provided, wherein the foam carrier has a compressive strength from 300 to 900 kPa, as determined according to DIN 53577-1988-12 at a deformation of 25%.

Embodiment 6. According to Embodiment 6, the adhesive element of Embodiment 1 is provided, wherein the foam carrier has a surface weight from 50 to 250 g/m².

Embodiment 7. According to Embodiment 7, the adhesive element of Embodiment 1 is provided, wherein the foam carrier is a closed-pore foam.

Embodiment 8. According to Embodiment 8, the adhesive element of Embodiment 1 is provided, wherein the one or more poly (meth) acrylate compounds have a combined mass fraction from 50% to 80%.

Embodiment 9. According to Embodiment 9, the adhesive element of Embodiment 1 is provided, wherein the one or more polymerizable poly (meth) acrylate compounds are derived from a polymerization of a monomer composition comprising one or more monofunctional (meth) acrylate compounds.

Embodiment 10. According to Embodiment 10, the adhesive element of Embodiment 1 is provided, wherein the one or more polymerizable epoxy compounds have a combined mass fraction from 15% to 45%.

Embodiment 11. According to Embodiment 11, the adhesive element of Embodiment 1 is provided, wherein the one or more polymerizable epoxy compounds are difunctional epoxy compounds.

Embodiment 12. According to Embodiment 12, the adhesive element of Embodiment 1 is provided, wherein the carrier layer has a mean thickness from 150 to 550 μm.

Embodiment 13. According to Embodiment 13, the adhesive element of Embodiment 1 is provided, wherein a ratio of a combined mean thickness of the first pressure-sensitive adhesive layer and the second pressure-sensitive adhesive layer divided by a mean thickness of the carrier layer is from 0.15 to 0.6.

Embodiment 14. According to Embodiment 14, a method for connecting two or more components with a reactive pressure-sensitive adhesive element is provided that includes: (a) providing the reactive pressure-sensitive adhesive element of the first aspect of the disclosure; (b) initiating a curing of the first UV-curable pressure-sensitive adhesive by activating the one or more photoinitiators in the first UV-curable pressure-sensitive adhesive by UV radiation; (c) initiating a curing of the second UV-curable pressure-sensitive adhesive by activating the one or more photoinitiators in the second UV-curable pressure-sensitive adhesive by UV radiation; and (d) connecting a first component and a second component to the reactive pressure-sensitive adhesive element to define a bonded substrate, wherein the connecting further comprises curing the first UV-curable pressure-sensitive adhesive and the second UV-curable pressure-sensitive adhesive.

Embodiment 15. According to Embodiment 15, the method of Embodiment 14 is provided, wherein the one or more polyolefins are selected from the group consisting of polyethylene, polypropylene, polyisobutylene, polybutylene and polymethylpentene.

Embodiment 16. According to Embodiment 16, the method of Embodiment 14 is provided, wherein a ratio of a combined mean thickness of the first pressure-sensitive adhesive layer and the second pressure-sensitive adhesive layer divided by a mean thickness of the carrier layer is from 0.15 to 0.6.

Embodiment 17. According to Embodiment 17, the method of Embodiment 14 is provided, wherein the bonded substrate includes: i.1 a first cured adhesive layer that is cohesively connected to the first component; ii.2 a second cured adhesive layer that is cohesively connected to the second component; and iii.3 a carrier layer that is cohesively connected to the first cured adhesive layer and the second cured adhesive layer.

Embodiment 18. According to Embodiment 18, a reactive pressure-sensitive adhesive element is provided that includes: i) a carrier layer; ii) a first adhesive layer arranged on a first surface of the carrier layer, wherein the first adhesive layer comprises a first UV-curable pressure-sensitive adhesive; and iii) a second adhesive layer arranged on a second surface of the carrier layer facing away from the first surface of the carrier layer and the first adhesive layer, wherein the second adhesive layer comprises a second UV-curable pressure-sensitive adhesive. Each of the first UV-curable pressure-sensitive adhesive and the second UV-curable pressure-sensitive adhesive, based on a mass of the respective pressure-sensitive adhesive, comprises: x) one or more poly (meth) acrylate compounds in a combined mass fraction from 35% to 85%; y) one or more polymerizable epoxy compounds in a combined mass fraction from 10% to 50%; and z) one or more photoinitiators in a combined mass fraction from 0.1% to 5%. Further, the carrier layer comprises a foam carrier.

Embodiment 19. According to Embodiment 19, the adhesive element of Embodiment 18 is provided, wherein the one or more poly (meth) acrylate compounds comprise a (co) polymer with a monomer base comprising a mass fraction of 70% to 85%, the monomer base selected from the group consisting of acrylic acid, methacrylic acid, acrylic acid esters, and methacrylic acid esters.

Embodiment 20. According to Embodiment 20, the adhesive element of Embodiment 18 is provided, wherein each of the first UV-curable pressure-sensitive adhesive and the second UV-curable pressure-sensitive adhesive further comprises one or more tackifier resins in a combined mass fraction from 1% to 25%.

1. A reactive pressure-sensitive adhesive element, comprising
i) a carrier layer;
ii) a first adhesive layer arranged on a first surface of the carrier layer, wherein the first adhesive layer comprises a first UV-curable pressure-sensitive adhesive; and
iii) a second adhesive layer arranged on a second surface of the carrier layer facing away from the first surface of the carrier layer and the first adhesive layer, wherein the second adhesive layer comprises a second UV-curable pressure-sensitive adhesive,
wherein each of the first UV-curable pressure-sensitive adhesive and the second UV-curable pressure-sensitive adhesive, based on a mass of the respective pressure-sensitive adhesive, comprises:
x) one or more poly (meth) acrylate compounds in a combined mass fraction from 35% to 85%;
y) one or more polymerizable epoxy compounds in a combined mass fraction from 10% to 50%; and
z) one or more photoinitiators in a combined mass fraction from 0.1% to 5%,
wherein the carrier layer comprises a foam carrier, the foam carrier comprising one or more polyolefins.

2. The adhesive element of claim 1, wherein the one or more polyolefins are selected from the group consisting of polyethylene, polypropylene, polyisobutylene, polybutylene and polymethylpentene.

3. The adhesive element of claim 1, wherein the one or more polyolefins are polyethylene.

4. The adhesive element of claim 1, wherein the foam carrier has a density from 200 to 600 kg/m³.

5. The adhesive element of claim 1, wherein the foam carrier has a compressive strength from 300 to 900 kPa, as determined according to DIN 53577-1988-12 at a deformation of 25%.

6. The adhesive element of claim 1, wherein the foam carrier has a surface weight from 50 to 250 g/m².

7. The adhesive element of claim 1, wherein the foam carrier is a closed-pore foam.

8. The adhesive element of claim 1, wherein the one or more poly (meth) acrylate compounds have a combined mass fraction from 50% to 80%.

9. The adhesive element of claim 1, wherein the one or more polymerizable poly(meth)acrylate compounds are derived from a polymerization of a monomer composition comprising one or more monofunctional(meth)acrylate compounds.

10. The adhesive element of claim 1, wherein the one or more polymerizable epoxy compounds have a combined mass fraction from 15% to 45%.

11. The adhesive element of claim 1, wherein the one or more polymerizable epoxy compounds are difunctional epoxy compounds.

12. The adhesive element of claim 1, wherein the carrier layer has a mean thickness from 150 to 550 μm.

13. The adhesive element of claim 1, wherein a ratio of a combined mean thickness of the first pressure-sensitive adhesive layer and the second pressure-sensitive adhesive layer divided by a mean thickness of the carrier layer is from 0.15 to 0.6.

14. A method for connecting two or more components with a reactive pressure-sensitive adhesive element, comprising:
a) providing the reactive pressure-sensitive adhesive element of claim 1;
b) initiating a curing of the first UV-curable pressure-sensitive adhesive by activating the one or more photoinitiators in the first UV-curable pressure-sensitive adhesive by UV radiation;
c) initiating a curing of the second UV-curable pressure-sensitive adhesive by activating the one or more photoinitiators in the second UV-curable pressure-sensitive adhesive by UV radiation; and
d) connecting a first component and a second component to the reactive pressure-sensitive adhesive element to define a bonded substrate, wherein the connecting further comprises curing the first UV-curable pressure-sensitive adhesive and the second UV-curable pressure-sensitive adhesive.

15. The method of claim 14, wherein the one or more polyolefins are selected from the group consisting of polyethylene, polypropylene, polyisobutylene, polybutylene and polymethylpentene.

16. The method of claim 14, wherein a ratio of a combined mean thickness of the first pressure-sensitive adhesive layer and the second pressure-sensitive adhesive layer divided by a mean thickness of the carrier layer is from 0.15 to 0.6.

17. The method of claim 14, wherein the bonded substrate comprises:
i. 1 a first cured adhesive layer that is cohesively connected to the first component;
ii.2 a second cured adhesive layer that is cohesively connected to the second component; and
iii.3 a carrier layer that is cohesively connected to the first cured adhesive layer and the second cured adhesive layer.

18. A reactive pressure-sensitive adhesive element, comprising
i) a carrier layer;
ii) a first adhesive layer arranged on a first surface of the carrier layer, wherein the first adhesive layer comprises a first UV-curable pressure-sensitive adhesive; and
iii) a second adhesive layer arranged on a second surface of the carrier layer facing away from the first surface of the carrier layer and the first adhesive layer, wherein the second adhesive layer comprises a second UV-curable pressure-sensitive adhesive,
wherein each of the first UV-curable pressure-sensitive adhesive and the second UV-curable pressure-sensitive adhesive, based on a mass of the respective pressure-sensitive adhesive, comprises:
x) one or more poly (meth) acrylate compounds in a combined mass fraction from 35% to 85%;
y) one or more polymerizable epoxy compounds in a combined mass fraction from 10% to 50%; and
z) one or more photoinitiators in a combined mass fraction from 0.1% to 5%,
wherein the carrier layer comprises a foam carrier.

19. The adhesive element of claim 18, wherein the one or more poly (meth) acrylate compounds comprise a (co) polymer with a monomer base comprising a mass fraction of 70% to 85%, the monomer base selected from the group consisting of acrylic acid, methacrylic acid, acrylic acid esters, and methacrylic acid esters.

20. The adhesive element of claim 18, wherein each of the first UV-curable pressure-sensitive adhesive and the second UV-curable pressure-sensitive adhesive further comprises one or more tackifier resins in a combined mass fraction from 1% to 25%.
